(19) United States
(12) Patent Application Publication
(10) Pub. No.: US 2020/0210903 A1
(43) Pub. Date: Jul. 2, 2020

(54) MULTI-PARTY EVENT RESERVATION SYSTEM AND METHOD

(71) Applicant: Luis Avila, Cathedral City, CA (US)

(72) Inventor: Luis Avila, Cathedral City, CA (US)

(21) Appl. No.: 16/728,149

(22) Filed: Dec. 27, 2019

Related U.S. Application Data
(60) Provisional application No. 62/786,269, filed on Dec. 28, 2018.

(51) Int. Cl. G06Q 10/02; G06Q 20/14; G06Q 10/10

(52) U.S. Cl. CPC G06Q 10/02; G06Q 10/107; G06Q 20/14

(57) ABSTRACT

Systems, devices, and methods for a novel computing device and method for enabling users to receive data regarding specific events based on the date, location, and artist performing at the event. A user can then select the desired event based on the criteria provided by the computing device. The user can determine which event reservation he or she wishes to join from a selection of event reservations already established by other users.

### CROSS-REFERENCE TO RELATED APPLICATIONS

This application claims priority to and the benefit of U.S. Provisional Patent Application No. 62/786,269, filed Dec. 28, 2018, the contents of which are hereby incorporated by reference herein for all purposes.

### TECHNICAL FIELD

Embodiments relate generally to entertainment ticketing, and more particularly to purchasing groups of entertainment tickets.

### BACKGROUND

A VIP refers to a very important person (VIP) who is accorded special privileges due to their status or importance, while a VIP reservation or VIP section refers herein to a set of rights or privileges to use an area with limited access, to receive special services, and/or enjoy extraordinary amenities typically excluded to those of a lower stature or admission level. In the case of a club or bar, for example, the VIP section may include a right to use a restricted area of the establishment with a better view of the entertainment, more comfortable seating, and higher levels of service from staff. These sets of amenities, which must generally be purchased at a premium price, are available only to a party that has purchased the VIP section while people holding general admission access may be excluded.

### SUMMARY

A method embodiment for a multi-party purchase of an event, may include: receiving, from a first user device associated with a first user of two or more users, a command to create a group purchase offering; generating, by a group facilitator server, a group purchase offering, where the group purchase offering comprises an event, a time, and the first user; transmitting, by the group facilitator server, the group purchase offering to a second user device associated with a second user of the two or more users; connecting, by the group facilitator server, the first user device and the second user device in response to a request by the second user device; adding, by the group facilitator server, the second user to the group purchase offering upon agreement between the first user and second user; and charging, by the group facilitator server, at least the first user and the second user a portion of a cost to reserve the group purchase offering.

In additional method embodiments, the event may be a VIP section. In additional method embodiments, the cost to reserve the VIP section may be shared between the first user and second user. In additional method embodiments, the cost to reserve the VIP section may be shared between three or more users including the first user and the second user. In additional method embodiments, the VIP section may be associated with an offer hosted by at least one of: a club company, a night club, a day club, and a sporting event. In additional method embodiments, the group facilitator server may be operated by a VIP affiliate. In additional method embodiments, the group facilitator server may be operated by an entity providing the VIP section.

In additional method embodiments, connecting the first user and second user may include: exchanging chat messages between the first user and second user. In additional method embodiments, connecting the first user and second user may include: exchanging email messages between the first user and second user. In additional method embodiments, the time of the group purchase offering comprises a start time and an end time.

A system embodiment may include: a first user device associated with a first user of two or more users; a second user device associated with a second user of two or more users; a group facilitator server in communication with the first user device and the second user device, the group facilitator server comprising a processor having addressable memory, the group facilitator server configured to: receive, from the first user device, a command to create a group purchase offering; generate a group purchase offering, where the group purchase offering comprises an event, a time, and the first user; transmit the group purchase offering to a second user device associated with a second user of the two or more users; connect the first user device and the second user device in response to a request by the second user device; add the second user to the group purchase offering upon agreement between the first user and second user; charge at least the first user and the second user a portion of a cost to reserve the group purchase offering.

In additional system embodiments, the event may be a VIP section. In additional system embodiments, the cost to reserve the VIP section may be shared between the first user and second user. In additional system embodiments, the cost to reserve the VIP section may be shared between three or more users including the first user and the second user. In additional system embodiments, the VIP section may be associated with an offer hosted by at least one of: a club company, a night club, a day club, and a sporting event. In additional system embodiments, the group facilitator server may be operated by a VIP affiliate. In additional system embodiments, the group facilitator server may be operated by an entity providing the VIP section.

In additional system embodiments, the group facilitator server may be further configured to: exchange chat messages between the first user and second user. In additional system embodiments, the group facilitator server may be further configured to: exchange email messages between the first user and second user. In additional system embodiments, the time of the group purchase offering comprises a start time and an end time.

The aspects of the different embodiments relate to a system and method for selling a single VIP section to multiple people at the time of the initial reservation booking. System embodiments may include a computing device for enabling users to receive data regarding specific events based on the date, location, and artist performing at the event. A user can then select the desired event based on the criteria provided by the computing device. Next the user can determine which event reservation he or she wishes to join from a selection of event reservations already established by other users. In the alternative, the user may create his or her own reservation and wait for another user to join. The user can also determine how the event reservation will be paid between the other users that join in the event reservation. For example, two or more users joining a single event reservation may both agree to pay cash, pay with card, or one with card and the other with cash at the event. Whether they both pay cash, they must both split the reservation booking fee. To facilitate this agreement, the system includes communication tools that enable the users to chat with one another and decide means of payment for the event. The computing device then holds the reservation and charges the users on behalf of the entertainment establishment offering the event being reserved.

Information about the event may also be made available to other users via the computing device. The computing device may then identify additional users searching for other people to join them for a specific event, and then transmit that information back to those users.

Once all the users joining a reservation are joined, that reservation may be transmitted to an affiliate company that manages the club's reservations. As such, the present embodiments consolidate orders on behalf of an affiliate company, which then books the reservation. In addition to selling event reservations on behalf of a company managing a club, the different embodiments of the system may be used by a company that sells the entertainment themselves.

The present embodiments facilitate the sale using a network technology that enables people to communicate for purposes of deciding which event to purchase. In addition, the initial purchasers of the VIP section may also invite others to then join the VIP section, further reducing the financial burden on the initial purchasers. This enables multiple customers, sometimes complete strangers, to effectively split the reservation cost and purchase entertainment they might not otherwise be willing or able to purchase.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 is a functional block diagram of a network and computing systems configured to implement the Multi-Party VIP Purchase (MOVP) system, in accordance with the embodiments of the present application;

FIG. 2 is a diagrammatic illustration of a user interface for organizing a VIP section purchase on the MOVP system;

FIG. 3 is a functional block diagram of a group facilitator server for bringing multiple users together to purchase VIP sections;

FIG. 4 is a diagrammatic illustration of the communications links with the group facilitator;

FIG. 5 is a flow chart of the method of creating and purchasing a VIP section;

FIG. 6 shows a high-level block diagram and process of a computing system for implementing an embodiment of the system and process;

FIG. 7 shows a block diagram and process of an exemplary system in which an embodiment may be implemented; and

FIG. 8 depicts a cloud computing environment for implementing an embodiment of the system and process disclosed herein.

### DETAILED DESCRIPTION

The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Customers that wish to purchase a VIP reservation may do so from a set of affiliates who sell tickets and VIP sections on behalf of the club's manager, who represents the club for purposes of selling services. The affiliates and managers work together but they are separate entities. In some cases, the club manager sells tickets and VIP sections through its own company.

A VIP section may be purchased by an individual and then used by a group of people including the purchaser and people invited by the purchaser, i.e., invitees. As such, each VIP is reserved or otherwise acquired by one and only one purchaser. Although the purchaser may receive compensation or other contribution from the invitees, the purchaser must necessarily possess the cash or credit in the amount of the total purchase price of the VIP section at the time of purchase.

In some cases, the purchaser organizes the purchase of the entertainment prior to the purchase. In that case, however, the purchaser must buy the entertainment with friends that he or she already knows and trust. This makes it challenging to find and organize a group of people for the purchase of the VIP section, especially when those friends are out of town, disinterested, or otherwise unavailable. In this case, the purchaser may have to default to general admission or simply purchase the VIP reservation alone. Although some clubs allow multiple customers at the same VIP section to split the purchase price of the VIP section across a few credit cards, the purchasers are offered this option only after they are inside the establishment. One person of the multiple customers may be burdened with the responsibility of the reservation fee and ultimately the entire VIP cost. There is therefore a need for a technology that avoids burdening a single purchaser with the cost of the VIP reservation fee and VIP section fee.

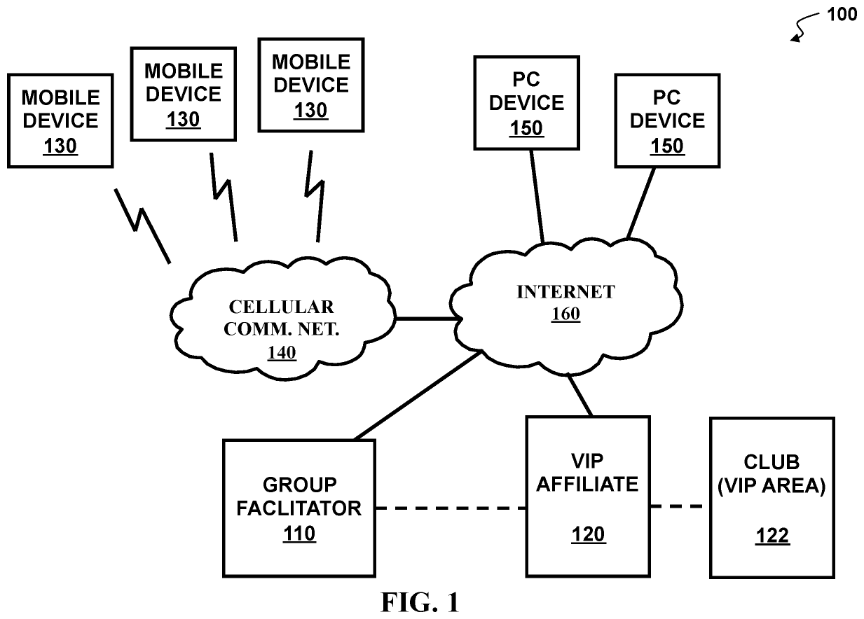

FIGS. 1-8 and the following discussion provide a description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

The present embodiments feature a novel computing device and method for enabling users to receive data regarding specific events based on the date, location, and artist performing at the event. A user can then select the desired event based on the criteria provided by the computing device. Next the user can determine which event reservation he or she wishes to join from a selection of event reservations already established by other users. In the alternative, the user may create his or her own reservation and wait for another user to join. The user can also determine how the event reservation will be paid between the other users that join in the event reservation. For example, two or more users joining a single event reservation may both agree to pay cash, pay with card, or one with card and the other with cash at the event. In some embodiments, each user may use another payment method, such as an electronic funds transfer, a payment application such as Zelle® or Venmo®, or the like. Each user must split the reservation booking fee regardless of payment method. To facilitate this agreement, the system includes communication tools that enable the users to chat with one another and decide means of payment for the event. The computing device then holds the reservation and charges the users on behalf of the entertainment establishment offering the event being reserved.

Information about the event may also be made available to other users via the computing device. The computing device may then identify additional users searching for other people to join them for a specific event, and then transmit that information back to those users.

Once all the users joining a reservation have joined, that reservation may be transmitted to an affiliate company that manages the club's reservations. As such, the present embodiments consolidate orders on behalf of an affiliate company, which then books the reservation. In addition to selling event reservations on behalf of a company managing a club, the different embodiments of the system may be used by a company that sells the entertainment themselves.

The aspects of the different embodiments relate to a system and method for selling a single VIP section to multiple people at the time of the initial reservation booking. The present embodiments facilitate the sale using a network technology that enables people to communicate for purposes of deciding which event to purchase. In addition, the initial purchasers of the VIP section may also invite others to then join the VIP section, further reducing the financial burden on the initial purchasers. This enables multiple customers, sometimes complete strangers, to effectively split the reservation cost and purchase entertainment they might not otherwise be willing or able to purchase.

Illustrated in FIG. 1 is a functional block diagram of a network and computing system configured to implement the Multi-Party VIP Purchase (MOVP) system 100 of the present embodiments. The MOVP system includes a group facilitator 110 configured to interact with both customers as well as VIP affiliates 120 that are contracted with clubs 122 to offer and sell their VIP areas. In particular, the group facilitator 110 includes a server for hosting webpages listing the VIP sections that are available for purchase. Customers may then access these webpages for purposes of viewing offerings as well as communicating with other people also interested in sharing the purchase price of a VIP section. The customers may access the webpages via mobile phones 130, via the cellular network 140, and the Internet 160, for example. Customers may also connect to the group facilitator 110 via any of a number of computing devices represented by personal computers (PC) 140 operably coupled to the Internet. Once the plurality of people have agreed on a VIP section or other event, those people may then actually purchase the VIP section through the group facilitator 110 and the order may be submitted to the VIP affiliate 120.

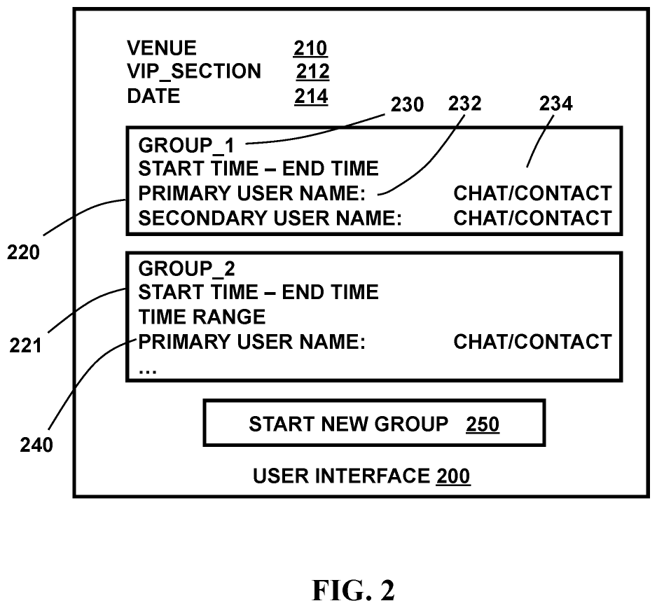

Illustrated in FIG. 2 is a diagrammatic illustration of a user interface for organizing a VIP section purchase on the MOVP system 100. The user interface 200, preferably a webpage, corresponds to a single venue such as a club or sporting event, for example. The name 210 of the club or other venue is at the top of the page along with the name 212 of the VIP section or area and the date 214 of the intended reservation. While the venue 210, VIP section 212, and date 214 are shown, other identifying information is possible and contemplated on the user interface 200. The webpage depicted may be one of a plurality of venues and VIP sections being offered for purchase on the MOVP system 100. A particular VIP section of interest may be located from among a database of the venues and VIP sections, all of which may be searchable by conventional means including keywords, club name, artist name, performer name, date and time of the VIP reservation, as well a geographical constraints such as city or state.

In one embodiment, more than one VIP section may be purchased on the MOVP system 100 by a user 232. For example, the user 232 may wish to purchase VIP sections 212 “in bulk” for a single date 214, potentially at a reduced cost offered by the club or VIP affiliate 120. In another embodiment, the user 232 may wish to purchase VIP sections 212 in bulk for a single venue 210 across multiple dates 214, again potentially at a reduced cost offered by the club or VIP affiliate 120. For example, a performer may be performing at a venue 210 for multiple evenings, and a primary user may be presented with the option of more than one date 214 for purchase at a time.

In one embodiment, a price range of a VIP section and a maximum number of VIP section occupants may be presented on the user interface. A primary user may have an idea, prior to purchase of the VIP section 212, what the potential cost may be to the primary user if, for example, the cost of the VIP section 212 were to be divided equally among the total number of occupants. Similarly, a secondary user may have an idea of what the potential cost may be prior to contacting the primary user.

After the user has located a particular VIP section of interest, the user is presented with the webpage 200. In addition to the club name 210, section name 212, and date 214, the webpage may further include one or more group purchase offerings 220-221. Each group purchase offering represents one group of people that have agreed to collectively purchase or seek to collectively purchase, as a group, an individual VIP section or area for a particular time. Group_1 220, for example, includes a primary user and a secondary user represented by their respective names 232. These two people have agreed to purchase the VIP section 212 for the period of time given by the Start Time and End Time. In some embodiments, the VIP section 212 may only have a start time, may only have an end time, may have an overall time limit, or may not have a start or end time.

In one embodiment, the users 232 are presented with additional options as part of the group offerings, such as promotional options with the costs to be split among the users prior to (or after) the time of purchase of the VIP section 212. For example, food and/or beverages (e.g., bottle service) may be offered by the venue and the users may discuss and decide to include, and, hence, split the costs of these extra services

Depending on the size of the VIP section and the number of people, the primary and secondary users may choose to leave open the offering for other people to join. To join an existing group, an interested person first clicks on the chat/message link 234 to contact the existing purchaser(s) and get approval to join the group purchase offering. This discussion may include an exchange of information including the number of people to be added to the group, the total number of people to which the group may be limited, cost information for joining the group, and payment information in order to compensate the primary and/or secondary users to the extent they have made any payment for the reservation. If approved, in one embodiment, the new purchaser name and contact information may be added to the list for Group _1 220.

The interested party may choose any one of the plurality of group purchase offerings 220-221 depending on when the interested party wants to join the VIP section. If the party wants a later time, for example, the party may request to join the second group Group _2 221 or a later group. As described above, in one embodiment joining would involve using the chat/message link to contact a primary purchaser 240 for purposes of coming to agreement about the number of people and form of payment, for example. If and when agreement is reached, the new party (e.g., a secondary user) makes a payment directly to the purchaser(s), i.e., primary user 240. In an alternative embodiment, the new user's payment information is charged a portion of the VIP section purchase prices along with the primary user 240.

In addition to joining an existing group purchase offering, a person may start a new group purchase offering by clicking on the link 250. In this situation, the person can control the time of the VIP section reservation as well as which people can join the reservation. If and when additional users are admitted into the new group, their portion of the cost of the VIP section can be made directly to the person that initially created the particular group, or both the initiator and the new user are both charged a fractional cost of the VIP section by the group facilitator, for example.

In each of the cases described above, the users 232 are sharing the cost of the VIP section or event so that no individual is responsible for the entire cost of the VIP section. In addition, the users sharing the cost of the VIP section may meet online and coordinate the purchase of the VIP section via the group facilitator server 110. As such, the users need not necessarily know each other prior to agreeing to purchase the VIP section together. This technology therefore enables complete strangers to coordinate the collective purchase of a VIP section, thus opening up the possibility of a VIP section purchase to a much wider range of people. The increase in demand for the VIP sections may then translate into increased sales of VIP sections.

In one embodiment, the primary user is in charge of refunds for cancellations by other users. In another embodiment, the venue (via the VIP affiliates of the group facilitator 110) controls the cancellation/refund policies.

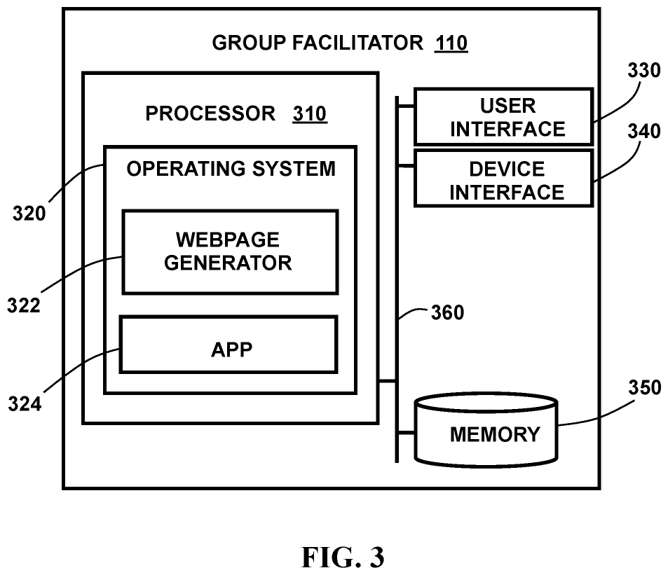

Illustrated in FIG. 3 is a functional block diagram of a group facilitator 110 for bringing multiple users together to purchase VIP sections. The group facilitator 110 in this embodiment is a server or similar computing device configured to generate webpages, generate groups for purposes of purchasing VIP sections, and transmit those purchases to the VIP affiliates 120 or to the clubs 122 directly. The group facilitator server 110 preferably includes a processor, central processing unit (CPU) 310, or processor array for running an operating system 320 like Apache, for example. On top of the operating system 320 is a web page generator 322 and one or more software applications 324, which collectively execute keyword searches of VIP sections in response to user queries, generate webpages to organize VIP section purchases on the MOVP system, connect multiple users for purposes of chatting about the terms of VIP section purchase, and charging users their respective portion of the VIP section purchase price.

In further reference to FIG. 3, an example of a top-level functional block diagram of a computing device embodiment is illustrated. The example operating environment is shown as a computing device 320 comprising a processor 310, such as a central processing unit (CPU), addressable memory 350, an external device interface 340, e.g., an optional universal serial bus port and related processing, and/or an Ethernet port and related processing, and an optional user interface 330, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 360. In some embodiments, via an operating system 320 such as one supporting a web browser and applications 324, the processor 310 may be configured to execute steps of a process establishing a communication channel and processing according to the embodiments described above.

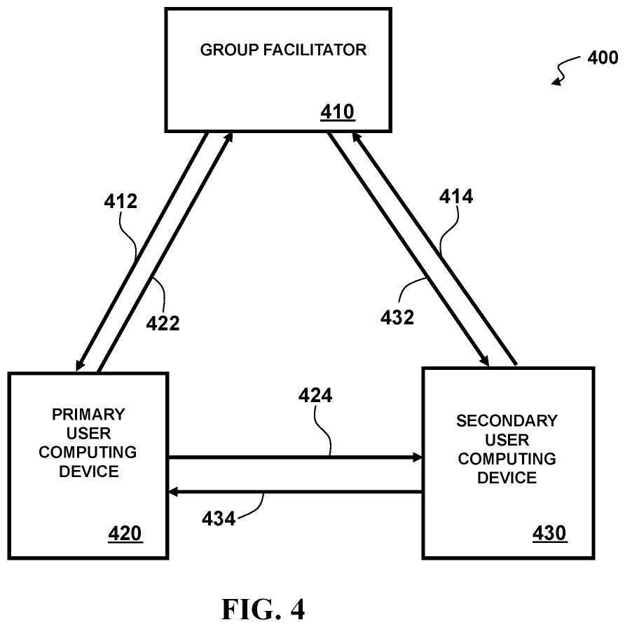

Illustrated in FIG. 4 is a diagrammatic illustration of the communications links supported by the present embodiments. In the disclosed embodiment, the group facilitator 410 communicates with a primary user 420 of a first group as well as a secondary user 430 also of the first group. With respect to the primary user 420, the group facilitator 410 transmits information 412 about one or more VIP sections available for reservation. In response, the primary user 420 transmits his or her selected VIP section 422, and in one embodiment, their personal contact information may be included in the group purchase offering, as shown in FIG. 2. When a secondary user searches the group facilitator 410, the group facilitator may transmit one or more group purchase offerings 432 posted by other primary users. If interested, the secondary user 430 may contact the primary user 420 or an administrator to determine price and payment information to buy into the group VIP section. The communication between the primary user 420 and secondary user 430 maybe direct, as represented by communications 424 and 434. In another embodiment, the messages between the primary user 420 and secondary user 430 may be indirect and utilize the group facilitator 410 as an intermediary. Once the secondary user 430 has selected a group purchase offering and the primary user admitted the secondary user into the group, the secondary user's name, and perhaps contact information may be added to the group purchase offering posted on the VIP section webpage.

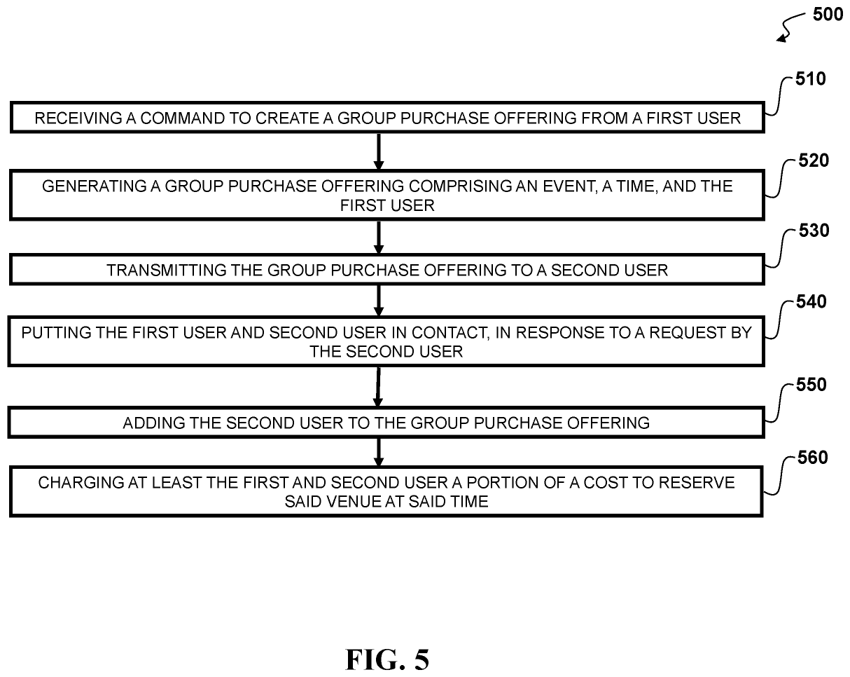

Illustrated in FIG. 5 is a flow chart of a method 500 by which a group facilitator system enables users to create a reservation for other users to see and collectively purchase a VIP section or other event. Once an event available for purchase is identified, a first user of two or more users transmits a command to the group facilitator server to create a group purchase offering. This command is received by the group facilitator server (step 510). The group purchase offering is a representation of the event to be reserved and purchased by the first user and at least one other user. The group purchase offer may include an event, a VIP section of one or more VIP sections, a time, and at least the name or username of the first user. The time may include a start time, an end time, a time limit, or the like. The group purchase offering is generated by the group facilitator server (step 520). The group purchase offering is then transmitted to or otherwise made available to other users, including a second user, interested in sharing the cost of the event (step 530). In some embodiments, the group purchase offering may be hidden, such as via a password protection, link that is not publicly available, or the like. In other embodiments, the group purchase offering may be publicly available such as via a listing of group purchase offerings that may be sorted by place, time, price, or the like.

Upon receipt of the group purchase offering, a second user of two or more users is invited to contact the first user for purposes of coming to agreement as to shared costs and method(s) of payment. The users may contact each other via a private channel. In some embodiments, the contact information and/or identity of one or more users may not be revealed unless consented to by both parties. In this embodiment, the group facilitator server may put the first user and second user in contact in response to a request by the second user (step 540). The contact between users may be via a chat program or messaging program, either directly or through an intermediary provided by methods that are known in the art. Upon agreement between the first user and second user, the group facilitator adds the second user to the group purchase offering along with the first user (step 550). By adding the second user to the list, the first and second users have effectively agreed to share the costs to purchase the event. In some embodiments, additional users may also join the reservation and share the cost of the event, thereby further reducing the cost each person must pay for the event. Thereafter, the group facilitator server or affiliate entity charges at least the first and second user for their respective portions of the cost to reserve and/or buy said event at said time (step 560).

The illustrations and examples provided herein are for explanatory purposes and are not intended to limit the scope of the appended claims. This disclosure is to be considered an exemplification of the principles of the embodiments and is not intended to limit the spirit and scope of the invention and/or claims of the embodiment illustrated. It is contemplated that various combinations and/or sub-combinations of the specific features, systems, methods, and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

One or more embodiments of the present embodiments may be implemented with one or more electrical circuits comprising integrated circuits and/or optical circuits comprising discrete electronic components or integrated circuits, for example. One or more embodiments of the present application may also be implemented with one or more optical computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer, processor, or module capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including personal computing devices, servers, general purpose computers, special purpose computers, application-specific integrated circuit (ASIC), and digital/analog circuits with discrete components, for example.

Although the description above contains many specifications, these should not be construed as limiting the scope of the invention but as merely providing illustrations of some of the presently embodiments of this invention. Therefore, the invention has been disclosed by way of example and not limitation, and reference should be made to the following claims to determine the scope of the present invention.

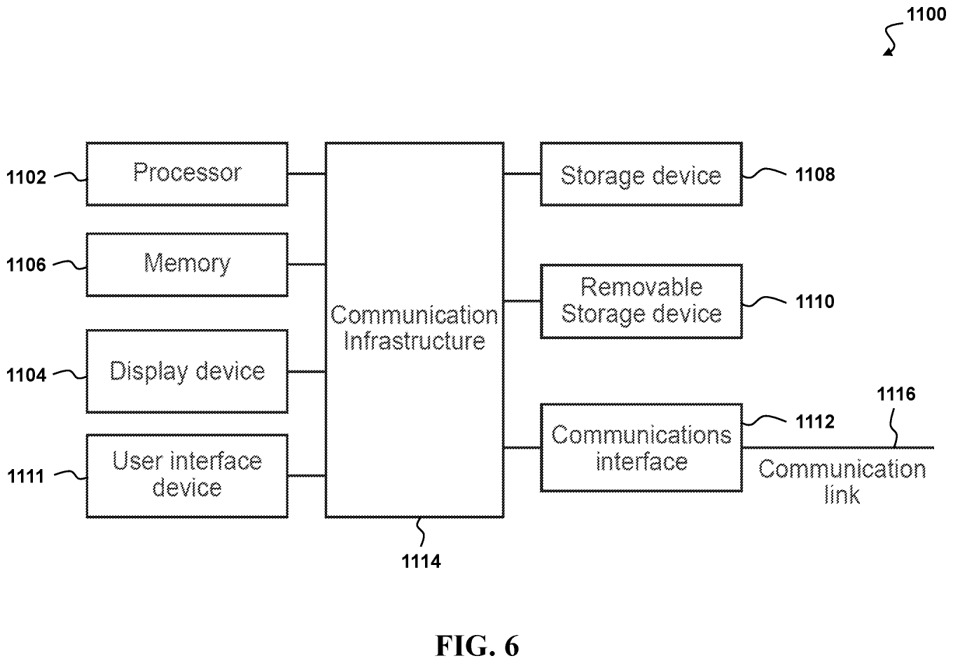

FIG. 6 is a high-level block diagram 1100 showing a computing system comprising a computer system useful for implementing an embodiment of the system and process, disclosed herein. Embodiments of the system may be implemented in different computing environments. The computer system includes one or more processors 1102, and can further include an electronic display device 1104 (e.g., for displaying graphics, text, and other data), a main memory 1106 (e.g., random access memory (RAM)), storage device 1108, a removable storage device 1110 (e.g., removable storage drive, a removable memory module, a magnetic tape drive, an optical disk drive, a computer readable medium having stored therein computer software and/or data), user interface device 1111 (e.g., keyboard, touch screen, keypad, pointing device), and a communication interface 1112 (e.g., modem, a network interface (such as an Ethernet card), a communications port, or a PCMCIA slot and card). The communication interface 1112 allows software and data to be transferred between the computer system and external devices. The system further includes a communications infrastructure 1114 (e.g., a communications bus, cross-over bar, or network) to which the aforementioned devices/modules are connected as shown.

Information transferred via communications interface 1114 may be in the form of signals such as electronic, electromagnetic, optical, or other signals capable of being received by communications interface 1114, via a communication link 1116 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1112. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

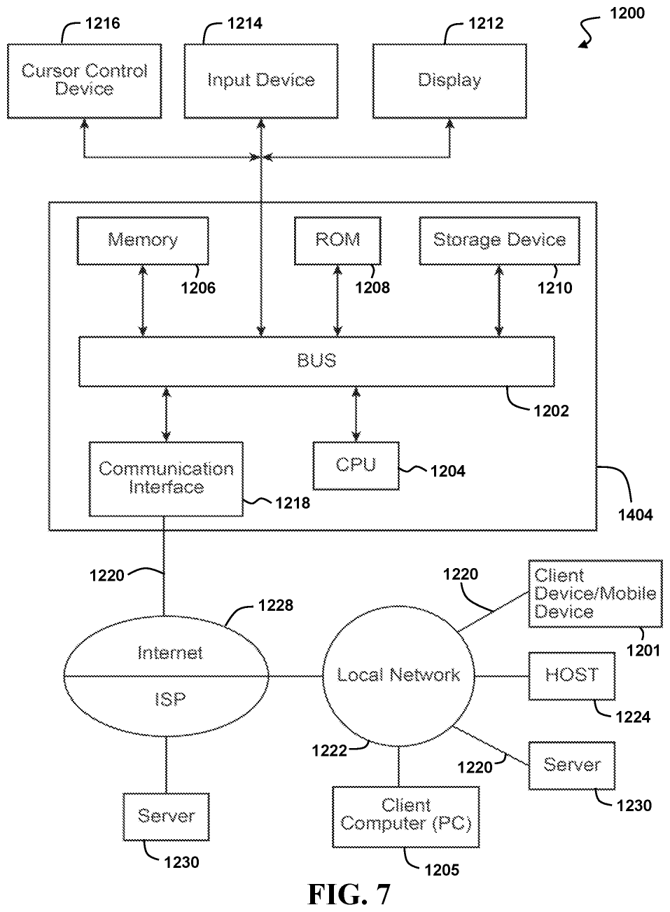

FIG. 7 shows a block diagram of an example system 1200 in which an embodiment may be implemented. The system 1200 includes one or more client devices 1201 such as consumer electronics devices, connected to one or more server computing systems 1230. A server 1230 includes a bus 1202 or other communication mechanism for communicating information, and a processor (CPU) 1204 coupled with the bus 1202 for processing information. The server 1230 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution or instructions to be executed by the processor 1204. The server computer system 1230 further includes a read only memory (ROM) 1208 or other static storage device coupled to the bus 1202 for storing static information and instructions for the processor 1204. A storage device 1210, such as a magnetic disk or optical disk, is provided and coupled to the bus 1202 for storing information and instructions. The bus 1202 may contain, for example, thirty-two address lines for addressing video memory or main memory 1206. The bus 1202 can also include, for example, a 32-bit data bus for transferring data between and among the components, such as the CPU 1204, the main memory 1206, video memory and the storage 1210. Alternatively, multiplex data/address lines may be used instead of separate data and address lines.

The server 1230 may be coupled via the bus 1202 to a display 1212 for displaying information to a computer user. An input device 1214, including alphanumeric and other keys, is coupled to the bus 1202 for communicating information and command selections to the processor 1204. Another type or user input device comprises cursor control 1216, such as a mouse, a trackball, or cursor direction keys for communicating direction information and command selections to the processor 1204 and for controlling cursor movement on the display 1212.

According to one embodiment, the functions are performed by the processor 1204 executing one or more sequences of one or more instructions contained in the main memory 1206. Such instructions may be read into the main memory 1206 from another computer-readable medium, such as the storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1204 for execution. Such a medium may take many forms, including but not limited to, non-volatile media, volatile media, and transmission media. Non-volatile media includes, for example, optical or magnetic disks, such as the storage device 1210. Volatile media includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the server 1230 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received from the main memory 1206 may optionally be stored on the storage device 1210 either before or after execution by the processor 1204.

The server 1230 also includes a communication interface 1218 coupled to the bus 1202. The communication interface 1218 provides a two-way data communication coupling to a network link 1220 that is connected to the world wide packet data communication network now commonly referred to as the Internet 1228. The Internet 1228 uses electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

In another embodiment of the server 1230, interface 1218 is connected to a network 1222 via a communication link 1220. For example, the communication interface 1218 may be an integrated services digital network (ISDN) card or a modem to provide a data communication connection to a corresponding type of telephone line, which can comprise part of the network link 1220. As another example, the communication interface 1218 may be a local area network (LAN) card to provide a data communication connection to a compatible LAN. Wireless links may also be implemented. In any such implementation, the communication interface 1218 sends and receives electrical electromagnetic or optical signals that carry digital data streams representing various types of information.

The network link 1220 typically provides data communication through one or more networks to other data devices. For example, the network link 1220 may provide a connection through the local network 1222 to a host computer 1224 or to data equipment operated by an Internet Service Provider (ISP). The ISP in turn provides data communication services through the Internet 1228. The local network 1222 and the Internet 1228 both use electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

The server 1230 can send/receive messages and data, including e-mail, program code, through the network, the network link 1220 and the communication interface 1218. Further, the communication interface 1218 can comprise a USB/Tuner and the network link 1220 may be an antenna or cable for connecting the server 1230 to a cable provider, satellite provider or other terrestrial transmission system for receiving messages, data and program code from another source.

The example versions of the embodiments described herein may be implemented as logical operations in a distributed processing system such as the system 1200 including the servers 1230. The logical operations of the embodiments may be implemented as a sequence of steps executing in the server 1230, and as interconnected machine modules within the system 1200. The implementation is a matter of choice and can depend on performance of the system 1200 implementing the embodiments. As such, the logical operations constituting said example versions of the embodiments are referred to for e.g., as operations, steps or modules.

Similar to a server 1230 described above, a client device 1201 can include a processor, memory, storage device, display, input device and communication interface (e.g., e-mail interface) for connecting the client device to the Internet 1228, the ISP, or LAN 1222, for communication with the servers 1230.

The system 1200 can further include computers (e.g., personal computers, computing nodes) 1205 operating in the same manner as client devices 1201, where a user can utilize one or more computers 1205 to manage data in the server 1230.

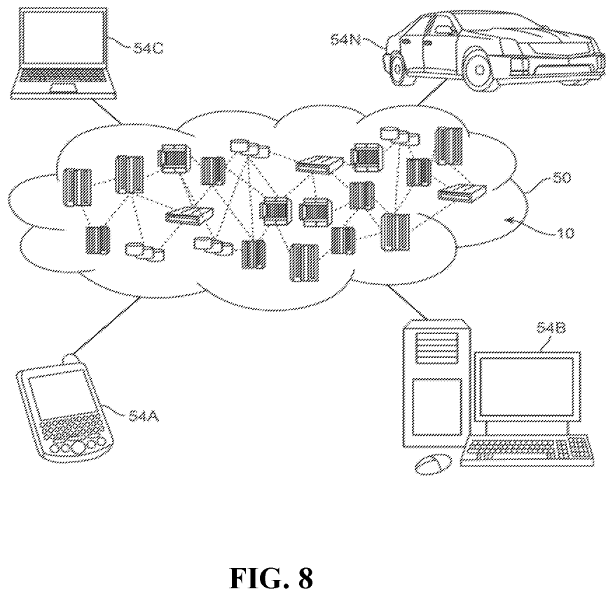

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A method for a multi-party purchase of an event, comprising:
receiving, from a first user device associated with a first user of two or more users, a command to create a group purchase offering;
generating, by a group facilitator server, a group purchase offering, wherein the group purchase offering comprises an event, a time, and the first user;
transmitting, by the group facilitator server, the group purchase offering to a second user device associated with a second user of the two or more users;
connecting, by the group facilitator server, the first user device and the second user device in response to a request by the second user device;
adding, by the group facilitator server, the second user to the group purchase offering upon agreement between the first user and second user; and
charging, by the group facilitator server, at least the first user and the second user a portion of a cost to reserve the group purchase offering.

2. The method of claim 1, wherein the event is a VIP section.

3. The method of claim 2, wherein the cost to reserve the VIP section is shared between the first user and second user.

4. The method of claim 3, wherein the cost to reserve the VIP section is shared between three or more users including the first user and the second user.

5. The method of claim 2, wherein the VIP section is associated with an offer hosted by at least one of: a club company, a night club, a day club, and a sporting event.

6. The method of claim 5, wherein the group facilitator server is operated by a VIP affiliate.

7. The method of claim 5, wherein the group facilitator server is operated by an entity providing the VIP section.

8. The method of claim 1, wherein connecting the first user and second user comprises:
exchanging chat messages between the first user and second user.

9. The method of claim 1, wherein connecting the first user and second user comprises:
exchanging email messages between the first user and second user.

10. The method of claim 1, wherein the time of the group purchase offering comprises a start time and an end time.

11. A system comprising:
a first user device associated with a first user of two or more users;
a second user device associated with a second user of two or more users;
a group facilitator server in communication with the first user device and the second user device, the group facilitator server comprising a processor having addressable memory, the group facilitator server configured to:
receive, from the first user device, a command to create a group purchase offering;
generate a group purchase offering, wherein the group purchase offering comprises an event, a time, and the first user;
transmit the group purchase offering to a second user device associated with a second user of the two or more users;
connect the first user device and the second user device in response to a request by the second user device;
add the second user to the group purchase offering upon agreement between the first user and second user;
charge at least the first user and the second user a portion of a cost to reserve the group purchase offering.

12. The system of claim 11, wherein the event is a VIP section.

13. The system of claim 12, wherein the cost to reserve the VIP section is shared between the first user and second user.

14. The system of claim 13, wherein the cost to reserve the VIP section is shared between three or more users including the first user and the second user.

15. The system of claim 12, wherein the VIP section is associated with an offer hosted by at least one of: a club company, a night club, a day club, and a sporting event.

16. The system of claim 15, wherein the group facilitator server is operated by a VIP affiliate.

17. The system of claim 15, wherein the group facilitator server is operated by an entity providing the VIP section.

18. The system of claim 11, wherein the group facilitator server is further configured to:
exchange chat messages between the first user and second user.

19. The method of claim 11, wherein the group facilitator server is further configured to:
exchange email messages between the first user and second user.

20. The method of claim 11, wherein the time of the group purchase offering comprises a start time and an end time.
